(19) United States
(12) Patent Application Publication
(10) Pub. No.: US 2024/0338178 A1
(43) Pub. Date: Oct. 10, 2024

(54) INTEGRATED CIRCUITS, SYSTEMS, AND METHODS FOR MULTIPLE-PRECISION MULTIPLY-AND-ACCUMULATE OPERATION

(71) Applicant: EDGECORTIX INC, Tokyo (JP)

(72) Inventors: Anudeep CHERLAPALLY, Kanagawa (JP); Nikolay NEZ, Tokyo (JP); Antonio Tomas Nevado VILCHEZ, Tokyo (JP)

(21) Appl. No.: 18/298,315

(22) Filed: Apr. 10, 2023

(51) Int. Cl. G06F 7/544; G06F 7/498; G06F 7/499

(52) U.S. Cl. CPC G06F 7/5443; G06F 7/4983; G06F 7/49915

(57) ABSTRACT

Multiple-precision multiply-and-accumulate operation is performed by a multiply-and-accumulate (MAC) unit configured to operate in an integer mode to perform computations on first data-width integer values to produce third data-width integer values and configured to operate in a floating point mode to perform computations on second data-width floating point values to produce third data-width floating point values, wherein the second data width is twice the first data width and the third data width is larger than the second data width. The MAC unit includes a first multiplier configured to multiply two integer values in the integer mode or multiply mantissa values extracted from each of two floating point values in the floating point mode. The MAC unit further includes a second multiplier, and is further configured to multiply two integer values in the integer mode or refrain from using the second multiplier in the floating point mode.

### BACKGROUND

Many neural network accelerators are configured to perform neural network inference using integer formats, such as INT8. Many neural network models are designed for floating point formats, such as FP32 and BF16. In order to perform inference of a neural network model designed for a floating point format using an accelerator configured for an integer format, the floating point values are quantized into integer values.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a system for multiple-precision multiply-and-accumulate operation, according to at least one embodiment of the present invention.

FIG. 2 is a portion of an integrated circuit for multiple-precision multiply-and-accumulate operation, according to at least one embodiment of the present invention.

FIG. 3 is a multiply-and-accumulate (MAC) unit for multiple-precision multiply-and-accumulate operation, according to at least one embodiment of the present invention.

FIG. 4 is a schematic diagram of a MAC unit performing multiply-and-accumulate operations in floating point mode, according to at least one embodiment of the present invention.

FIG. 5 is a schematic diagram of a MAC unit performing multiply-and-accumulate operations in integer mode, according to at least one embodiment of the present invention.

FIG. 6 is an operational flow for multiple-precision multiply-and-accumulate operation and activation, according to at least one embodiment of the present invention.

FIG. 7 is an operational flow for performing a multiply-and-accumulate computation, according to at least one embodiment of the present invention.

FIG. 8 is an operational flow for computing an exponent for a multiply-and-accumulate computation of a floating point value, according to at least one embodiment of the present invention.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

Quantization of some neural networks, such as quantization to use the INT8 format in place of the native FP32 format, leads to significant loss of accuracy and other important parameters when performing inference of the neural network.

Performing neural network inference using floating point formats has improved accuracy over using integer formats. Since many neural network models are designed for floating point formats, performing neural network inference using the floating point format reduces computational resource usage to quantize such neural network models to integer format.

At least some embodiments of the integrated circuits described herein support floating point formats along with integer formats. In at least some embodiments, the integrated circuits described herein support the Brain-Float 16 (BF16) format, which requires only half the bandwidth of FP32, yet covers the full value range of FP32, which enables similar accuracy to FP32. The data-width of BF16 is twice the bit-width of INT8. However, the mantissa, or significand, of BF16 is 8 bits, which matches the bit-width of INT8. This means for every 1 input of BF16 there are 2 inputs of INT8, and the amount of terra-operations-per-second (TOPS) will scale by 2 from BF16 to INT8.

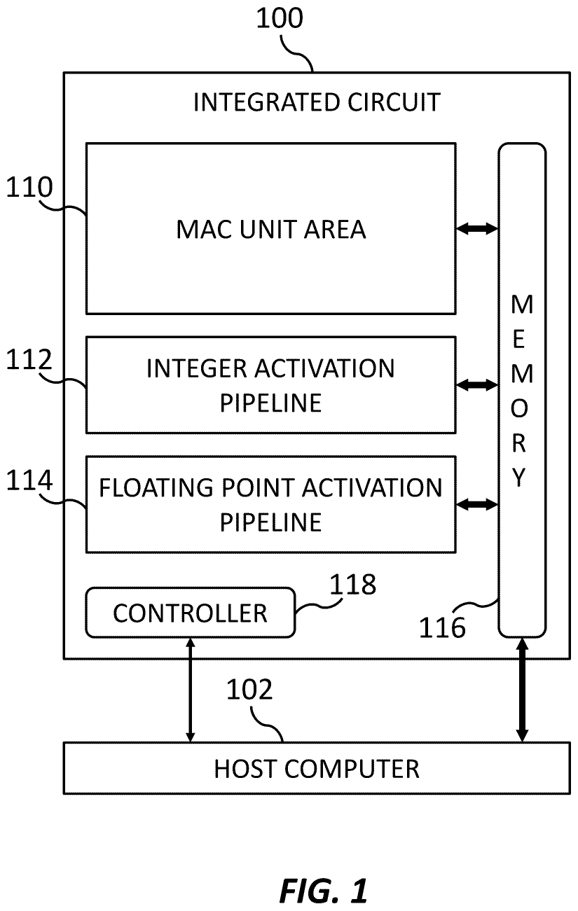

FIG. 1 is a system for multiple-precision multiply-and-accumulate operation, according to at least one embodiment of the present invention. The system includes an integrated circuit 100 and a host computer 102.

Integrated circuit 100 includes a MAC unit area 110, an integer activation pipeline 112, a floating point activation pipeline 114, a memory 116, and a controller 118. In at least some embodiments, integrated circuit 100 is an Application Specific Integrated Circuit (ASIC), including dedicated circuitry. In at least some embodiments, integrated circuit is a Field Programmable Gate Array (FPGA).

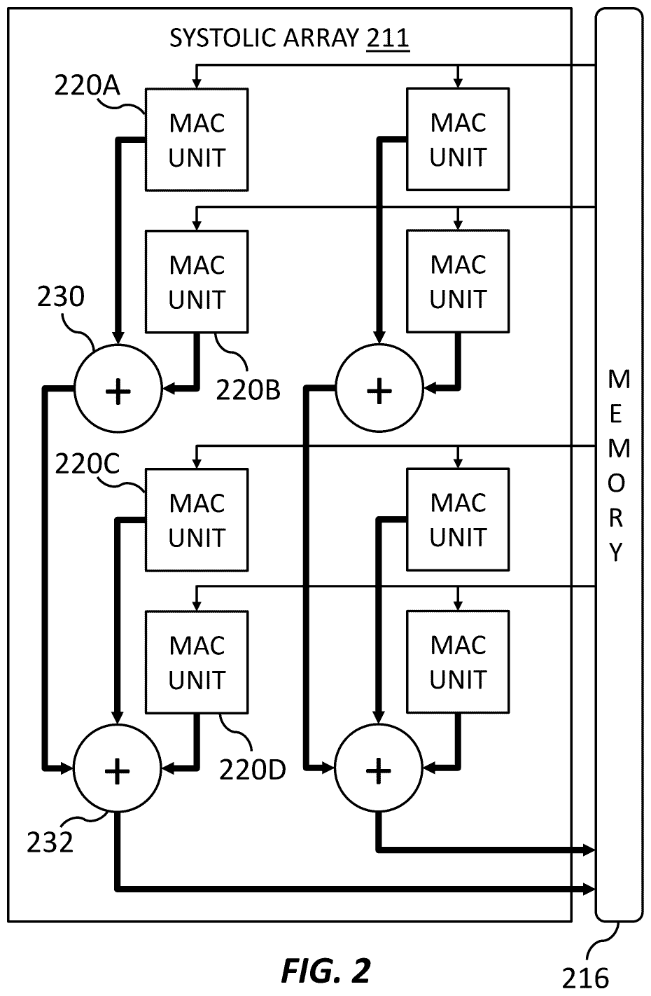

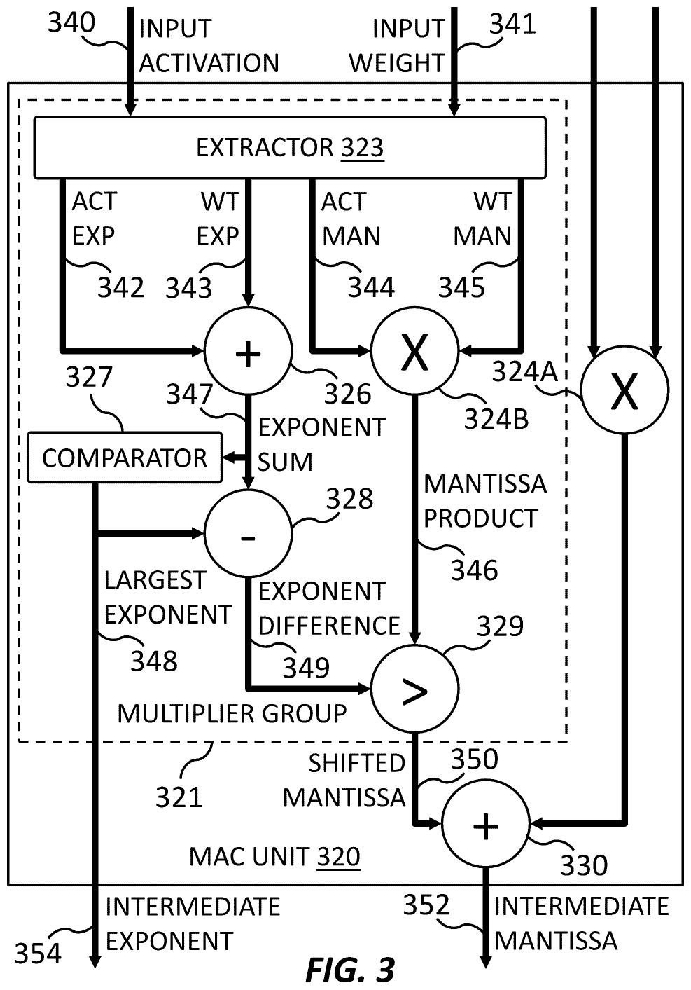

MAC unit area 110 is in communication with memory 116 and controller 118. In at least some embodiments, MAC unit area 110 performs dot product functions. In at least some embodiments, MAC unit area 110 includes a plurality of multipliers and adders. In at least some embodiments, MAC unit area 110 includes a plurality of MAC units and a plurality of accumulation adders. In at least some embodiments, MAC unit area 110 includes a plurality of multiplier groups, dedicated multipliers, and accumulation adders. In at least some embodiments, MAC unit area 110 is configured to operate in an integer mode to perform computations on first data-width integer values to produce third data-width integer values and configured to operate in a floating point mode to perform computations on second data-width floating point values to produce third data-width floating point values, wherein the second data width is twice the first data width and the third data width is larger than the second data width. In at least some embodiments, MAC unit area is a systolic array, such as systolic array 211 of FIG. 2, which will be described hereinafter. In at least some embodiments, MAC unit area is a single MAC unit and normalizing adder, such as MAC unit 320 of FIG. 3 and normalizing adder 232 of FIG. 2, which will be described hereinafter.

Integer activation pipeline 112 is in communication with memory 116 and controller 118. In at least some embodiments, integer activation pipeline 112 is configured to perform further operations on the output dot product of the systolic array. In at least some embodiments, integer activation pipeline 112 is configured to activate the third data-width integer value to produce an activated first data-width integer value. In at least some embodiments, integer activation pipeline 112 is configured to perform, in addition to activation functions, bias addition, residual additions, residual multiplications, quantizations, requantizations, and other operations that may be required for inference of a given neural network. In at least some embodiments, integer activation pipeline 112 includes at least one look-up table (LUT) for approximation of the activation function. In at least some embodiments, each LUT has a depth of M, and each location in an LUT store is a second data-width floating point value.

Floating point activation pipeline 114 is in communication with memory 116 and controller 118. In at least some embodiments, floating poing activation pipeline 114 is configured to configured to activate the third data-width floating point value to produce an activated second data-width floating point value. In at least some embodiments, floating point activation pipeline 114 is configured to perform, in addition to activation functions, bias addition, residual additions, residual multiplications, and other operations that may be required for inference of a given neural network. In at least some embodiments, floating point activation pipeline 114 performs conversions between the first data-width integer format and the second data-width floating point format. In at least some embodiments, floating point activation pipeline 114 includes at least one look-up table (LUT) for approximation of the activation function. In at least some embodiments, each LUT has a depth of M, and each location in an LUT store is a second data-width floating point value.

In at least some embodiments, memory 116 is configured to store values and to transmit stored values. In at least some embodiments, memory 116 includes one or more banks or blocks of volatile data storage, such as Random Access Memory (RAM), Embedded System Blocks (ESB), Content Addressable Memory (CAM), etc. In at least some embodiments, memory 116 is distributed throughout integrated circuit 100. In at least some embodiments, memory 116 is in communication with each MAC unit of MAC unit area 110 via one or more data paths, such as an interconnect or data bus. In at least some embodiments, memory 116 is configured to transmit and receive data values through data paths to and from MAC unit area 110, integer activation pipeline 112, and floating point activation pipeline 114.

Controller 118 is in communication with host computer 102, MAC unit area 110, integer activation pipeline 112, and floating point activation pipeline 114. In at least some embodiments, controller 118 includes circuitry configured to receive programs from host computer 102, such as programs including instructions for performing neural network inference. In at least some embodiments, controller 118 includes circuitry configured to transmit the program to one or more sequencers of MAC unit area 110, integer activation pipeline 112, and floating point activation pipeline 114. In at least some embodiments, controller 118 is configured to operate in the integer mode to perform neural network inference on first data-width integer values and configured to operate in the floating point mode to perform neural network inference on second data-width floating point values.

In at least some embodiments, host computer 102 is a personal computer, a server, a portion of cloud computing resources, or anything else capable of transmitting program instructions to integrated circuit 100 and storing resultant data. In at least some embodiments, host computer 102 is a notebook computer, a tablet computer, a smartphone, a smartwatch, an Internet of Things (IoT) device, etc. Host computer 102 is in communication with integrated circuit 100 through a control path and a data path. In at least some embodiments, host computer 102 includes an external memory, such as a Dynamic Random Access Memory (DRAM) configured to store programs, input data, and resultant data.

FIG. 2 is a portion of an integrated circuit for multiple-precision multiply-and-accumulate operation, according to at least one embodiment of the present invention. The portion includes systolic array 211 and memory 216.

Systolic array 211 includes a plurality of multiply-and-accumulate (MAC) units, such as MAC unit 220A, MAC unit 220B, MAC unit 220C, and MAC unit 220D, and a plurality of accumulation adders, such as accumulation adder 230 and normalizing accumulation adder 232.

Memory 216 is in communication with each MAC unit among the plurality of MAC units. In at least some embodiments, each MAC unit is configured to perform computations in the integer mode and is further configured to perform computations in the floating point mode. In at least some embodiments, each MAC unit is configured to read second data-width floating point values from memory 216, and each MAC unit is further configured to read first data-width integer values from memory 216. In at least some embodiments, each MAC unit among the plurality of MAC units includes a first multiplier, an exponent adder, a comparator, a subtractor, and a shifter. In at least some embodiments, each MAC unit further includes a second multiplier. In at least some embodiments, each MAC unit further includes at least one accumulation adder among the plurality of accumulation adders. In at least some embodiments, each MAC unit includes a plurality of instances of pairs of the first multiplier and the second multiplier, each first multiplier among the plurality of instances grouped with an instance of the exponent adder, an instance of the comparator, an instance of the subtractor, and an instance of the shifter.

Memory 216 is in communication with at least some accumulation adders among the plurality of accumulation adders. In at least some embodiments, each accumulation adder is connected to two or more of any combination of multipliers included in the plurality of MAC units and preceding accumulation adders. For example, accumulation adder 230 is connected to MAC unit 220A and MAC unit 220B, and normalizing accumulation adder 232 is connected to MAC unit 220C, MAC unit 220D, and accumulation adder 230, which is the preceding accumulation adder from the perspective of normalizing accumulation adder 232.

In at least some embodiments, the plurality of accumulation adders are collectively configured to accumulate intermediate mantissa values of the plurality of MAC units to produce an accumulation mantissa value, and the plurality of accumulation adders are collectively further configured to accumulate intermediate integer values of the plurality of MAC units to produce an accumulation integer value. For example, accumulation adder 230 and normalizing accumulation adder 232 are collectively configured to accumulate intermediate mantissa values or intermediate integer values of MAC unit 220A, MAC unit 220B, MAC unit 220C, and MAC unit 220D to produce an accumulation mantissa value or an accumulation integer value, which is stored on memory 216. In at least some embodiments, each accumulation adder is configured to perform floating point addition and integer addition, where the floating point addition includes shifting intermediate mantissa values based on the largest exponent. In at least some embodiments, the plurality of accumulation adders includes a normalizing accumulation adder further configured to normalize the accumulation mantissa value with the largest exponent value to produce a third data-width floating point value, and the normalizing accumulation adder is further configured to produce a third data-width integer value without normalizing. For example, normalizing accumulation adder 232 is further configured to normalize the accumulation mantissa value with an exponent value to produce a third data-width floating point value, and then store the third data-width floating point value in memory 216, or produce the third data-width integer value from the accumulation integer value without normalizing, and then store the third data-width integer value in memory 216.

In the foregoing example, MAC unit 220A, MAC unit 220B, MAC unit 220C, and MAC unit 220D are the plurality of MAC units, and accumulation adder 230 and normalizing accumulation adder 232 are the plurality of accumulation adders. In this way, systolic array 211 can be thought of as having multiple instances of a plurality of MAC units and a plurality of accumulation adders, with each instance configured to operate in an integer mode to perform computations on first data-width integer values to produce a third data-width integer value and configured to operate in a floating point mode to perform computations on second data-width floating point values to produce a third data-width floating point value. In at least some embodiments, each instance of a plurality of MAC units and a plurality of accumulation adders is one column of systolic array 211, as in MAC unit 220A, MAC unit 220B, MAC unit 220C, MAC unit 220D, accumulation adder 230, and normalizing accumulation adder 232, or one column of systolic array 211, depending on whether adders are connected vertically or horizontally.

FIG. 3 is a multiply-and-accumulate (MAC) unit 320 for multiple-precision multiply-and-accumulate operation, according to at least one embodiment of the present invention. MAC unit 320 includes a multiplier group 321, a dedicated multiplier 324A, and an accumulation adder 330. Multiplier group 321 includes an extractor 323, a group multiplier 324B, an exponent adder 326, a comparator 327, a subtractor 328, and a shifter 329. In at least some embodiments, a memory is in communication with each multiplier group among the plurality of multiplier groups and each dedicated multiplier among the plurality of multipliers. In at least some embodiments, MAC unit 320 is included in a systolic array of an integrated circuit. In at least some embodiments, MAC units 320 is included in an integrated circuit outside of any systolic array. In at least some embodiments, MAC unit 320 is configured to operate in an integer mode to perform computations on first data-width integer values to produce third data-width integer values and configured to operate in a floating point mode to perform computations on second data-width floating point values to produce third data-width floating point values, wherein the second data width is twice the first data width and the third data width is larger than the second data width.

Extractor 323 is connected to exponent adder 326 and group multiplier 324B. In at least some embodiments, extractor 323 is configured to extract an exponent value and a mantissa value from each of a plurality of second data-width floating point values, and extractor 323 is further configured to pass through at least two first data-width integer values among a plurality of first data-width integer values. In at least some embodiments, extractor 323 is configured to extract activation exponent value 342 and activation mantissa value 344 from input activation value 340, and extract weight exponent value 343 and weight mantissa value 345 from input weight value 341, where input activation value 340 and input weight value 341 are second data-width floating point values. In at least some embodiments, extractor 323 is configured to receive input activation value 340 and input weight value 341 from a memory. In at least some embodiments, each multiplier group is configured to read the plurality of second data-width floating point values from the memory, each multiplier group further configured to read the plurality of first data-width integer values from the memory. In at least some embodiments, extractor 323 is configured to transmit activation exponent value 342 and weight exponent value 343 to exponent adder 326, and is configured to transmit activation mantissa value 344 and weight mantissa value 345 to group multiplier 324B. In at least some embodiments, extractor 323 is configured to pass through input activation value 340 and input weight value 341 to group multiplier 324B, where input activation value 340 and input weight value 341 are first data-width integer values.

Group multiplier 324B is connected to extractor 323 and shifter 329. In at least some embodiments, group multiplier 324B is configured to multiply mantissa values extracted from each of two floating point values among the plurality of floating point values to produce a first mantissa product value, and group multiplier 324B is further configured to multiply two of the at least two first data-width integer values among the plurality of first data-width integer values to produce a first integer product value. In at least some embodiments, group multiplier 324B is configured to multiply activation mantissa value 344 and weight mantissa value 345 to produce mantissa product value 346, where input activation value 340 and input weight value 341 are second data-width floating point values. In at least some embodiments, group multiplier 324B is configured to multiply input activation value 340 and input weight value 341 to produce an integer product value, where input activation value 340 and input weight value 341 are first data-width integer values. In at least some embodiments, group multiplier 324B is configured to receive activation mantissa value 344 and weight mantissa value 345 from extractor 323, and is configured to transmit mantissa product value 346 to shifter 329. In at least some embodiments, group multiplier 324B is configured to receive input activation value 340 and input weight value 341 from extractor 323, and is configured to transmit the integer product value to shifter 329.

Exponent adder 326 is connected to extractor 323, comparator 327, and subtractor 328. In at least some embodiments, exponent adder 323 is configured to add exponent values extracted from each of the two floating point values among the plurality of floating point values to produce an exponent sum value. In at least some embodiments, exponent adder 323 is configured to add activation exponent value 342 and weight exponent value 343 to produce exponent sum value 347, where input activation value 340 and input weight value 341 are second data-width floating point values. In at least some embodiments, exponent adder 323 is configured to receive activation exponent value 342 and weight exponent value 343 from extractor 323, and is configured to transmit exponent sum value 347 to comparator 327 and subtractor 328. In at least some embodiments, exponent adder 323 is dormant where input activation value 340 and input weight value 341 are first data-width integer values.

Comparator 327 is connected to exponent adder 326 and subtractor 328. In at least some embodiments, comparator 327 is configured to determine a largest exponent value among a plurality of exponent sum values produced from a plurality of multiplier groups of a systolic array. In at least some embodiments, comparator 327 is configured to determine a largest exponent value among a plurality of exponent sum values produced from a plurality of MAC units of a systolic array. In at least some embodiments, comparator 327 is configured to determine largest exponent value 348 from among a plurality of exponent sum values, including exponent sum value 347, produced from a plurality of MAC units, including MAC unit 320, of a systolic array. In at least some embodiments, comparator 327 is in communication with a plurality of comparators, each comparator included in a corresponding MAC unit among the plurality of MAC units of the systolic array. In at least some embodiments, comparator 327 is in communication with the exponent adder and the subtractor included in each MAC unit among the plurality of MAC units of the systolic array. In at least some embodiments, comparator 327 is configured to determine a largest exponent value among a plurality of exponent values, including exponent values of third data-width floating point values resulting from previous iterations of computations. In at least some embodiments, comparator 327 is configured to receive exponent sum value 347 from exponent adder 326, and is configured to transmit largest exponent value 348 to subtractor 328. In at least some embodiments, comparator 327 is configured to transmit largest exponent value 348 as intermediate exponent value 354 to another comparator, another MAC unit, or an accumulation adder. In at least some embodiments, comparator 327 is dormant where input activation value 340 and input weight value 341 are first data-width integer values.

Subtractor 328 is connected to exponent adder 326, comparator 327, and shifter 329. In at least some embodiments, subtractor 328 is configured to subtract the exponent sum value from the largest exponent value to produce a difference. In at least some embodiments, subtractor 328 is configured to subtract exponent sum value 347 from largest exponent value 348 to produce exponent difference value 349. In at least some embodiments, subtractor 328 is configured to receive exponent sum value 347 from exponent adder 326 and largest exponent value 348 from comparator 327, and is configured to transmit exponent difference value 349 to shifter 329. In at least some embodiments, subtractor 328 is dormant where input activation value 340 and input weight value 341 are first data-width integer values.

Shifter 329 is connected to subtractor 328, group multiplier 324B, and accumulation adder 330. In at least some embodiments, shifter 329 is configured to shift the first mantissa product value based on the difference to produce an intermediate mantissa value, and shifter 329 is further configured to pass through the first integer product value as an intermediate integer value. In at least some embodiments, shifter 329 is configured to shift mantissa product value 346 based on exponent difference 349 to produce shifted mantissa value 350, where input activation value 340 and input weight value 341 are second data-width floating point values. In at least some embodiments, shifter 329 is configured to pass through the first integer product value as an intermediate integer value, where input activation value 340 and input weight value 341 are first data-width integer values. In at least some embodiments, shifter 329 is configured to receive mantissa product value 346 from group multiplier 324B and exponent difference value 349 from subtractor 328, and is configured to transmit shifted mantissa value 350 to accumulation adder 330. In at least some embodiments, shifter 329 is configured to receive the first integer product value from group multiplier 324B, and is configured to transmit the first integer product value to accumulation adder 330. In at least some embodiments, shifter 329 has a larger bit-width for increased accuracy. In at least some embodiments, shifter 329 has a smaller bit-width, which has decreased accuracy compared with the longer bit-width, but requires less hardware resources. In this manner, the bit-width of shifter 329 represents a trade-off between accuracy and hardware resource consumption.

Dedicated multiplier 324A is connected to accumulation adder 330. In at least some embodiments, dedicated multiplier 324A is configured to multiply two first data-width integer values among the plurality of first data-width integer values to produce a second integer product value. In at least some embodiments, dedicated multiplier 324A is configured to multiply a second input activation value and a second input weight value to produce a second integer product value, where input activation value 340 and input weight value 341 are first data-width integer values. In at least some embodiments, dedicated multiplier 324A is configured to receive the second input activation value and the second input weight value from a memory. In at least some embodiments, dedicated multiplier 324A is configured to transmit the second integer product value to accumulation adder 330. In at least some embodiments, dedicated multiplier 324A is dormant where input activation value 340 and input weight value 341 are second data-width floating point values.

Accumulation adder 330 is connected to shifter 329 and dedicated multiplier 324A. In at least some embodiments, accumulation adder 330 is configured to add the first integer product value to the second integer product value to produce an intermediate integer value. In at least some embodiments, accumulation adder 330 is configured to add the first integer product value to the second integer product value to produce an intermediate integer value, where input activation value 340 and input weight value 341 are first data-width integer values. In at least some embodiments, accumulation adder 330 is configured to add shifted mantissa value 350 to another shifted mantissa value from another multiplier group of MAC unit 320 to produce an intermediate mantissa value 352, where input activation value 340 and input weight value 341 are second data-width floating point values. In at least some embodiments, accumulation adder 330 is configured to receive the first integer product value from shifter 329 and the second integer product value from dedicated multiplier 324A, and accumulation adder 330 is configured to transmit the intermediate integer value to a subsequent accumulation adder. In at least some embodiments, accumulation adder 330 is configured to receive shifted mantissa value 350 from shifter 329 and the other shifted mantissa value from the other multiplier group of MAC unit 320, and accumulation adder 330 is configured to transmit intermediate mantissa value 352 to a subsequent accumulation adder. In at least some embodiments, accumulation adder 330 is one of a plurality of accumulation adders, each accumulation adder connected to two or more of any combination of shared multipliers among the plurality of multiplier groups, dedicated multipliers among the plurality of dedicated multipliers, and preceding accumulation adders, the plurality of accumulation adders collectively configured to accumulate the intermediate mantissa values of the plurality of multiplier groups to produce an accumulation mantissa value, the plurality of accumulation adders collectively further configured to accumulate the intermediate integer values of the plurality of multiplier groups and the plurality of dedicated multipliers to produce an accumulation integer value. In at least some embodiments, accumulation adder 330 has a larger bit-width for increased accuracy. In at least some embodiments, accumulation adder 330 has a smaller bit-width, which has decreased accuracy compared to the longer bit-width, but requires less hardware resources. In this manner, the bit-width of accumulation adder 330 represents a trade-off between accuracy and hardware resource consumption.

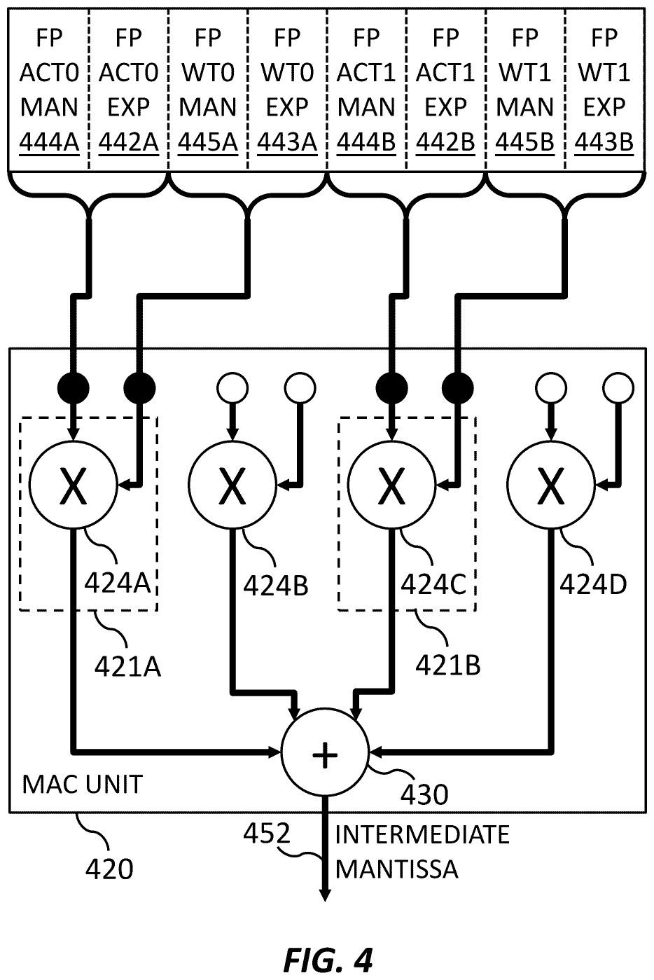

FIG. 4 is a schematic diagram of a MAC unit 420 performing multiply-and-accumulate operations in floating point mode, according to at least one embodiment of the present invention. MAC unit 420 includes multiplier group 421A including group multiplier 424A, dedicated multiplier 424B, multiplier group 421B including group multiplier 424C, dedicated multiplier 424D, and accumulation adder 430. Multiplier groups 421A and 421B, group multipliers 424A and 424C, dedicated multipliers 424B and 424D, and accumulation adder 430 are substantially similar in structure and function to multiplier group 321, group multiplier 324B, dedicated multiplier 324A, and accumulation adder 330 of FIG. 3, respectively, except as otherwise indicated.

In floating point mode, MAC unit 420 receives a plurality of floating point values including activation 0 mantissa 444A, activation 0 exponent 442A, weight 0 mantissa 445A, weight 0 exponent 443A, activation 1 mantissa 444B, activation 1 exponent 442B, weight 1 mantissa 445B, and weight 1 exponent 443B. In floating point mode, MAC unit 420 directs activation 0 mantissa 444A, activation 0 exponent 442A, weight 0 mantissa 445A, and weight 0 exponent 443A to multiplier group 421A, and directs activation 1 mantissa 444B, activation 1 exponent 442B, weight 1 mantissa 445B, and weight 1 exponent 443B to multiplier group 421B. In floating point mode, dedicated multiplier 424B and dedicated multiplier 424D are dormant. In at least some embodiments, MAC unit 420 is further configured to refrain from using dedicated multiplier 424B and dedicated multiplier 424D in the floating point mode. In floating point mode, multiplier group 421A and multiplier group 421B each transmit a shifted mantissa value to accumulation adder 430. In floating point mode, accumulation adder adds the shifted mantissa values to produce intermediate mantissa value 452.

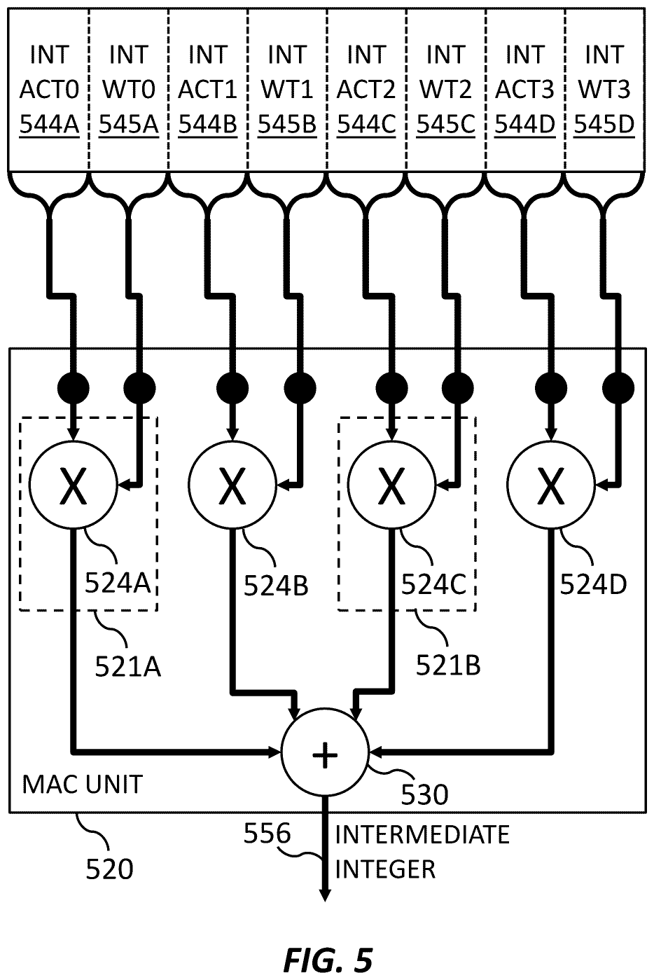

FIG. 5 is a schematic diagram of a MAC unit 520 performing multiply-and-accumulate operations in integer mode, according to at least one embodiment of the present invention. MAC unit 520 includes multiplier group 521A including group multiplier 524A, dedicated multiplier 524B, multiplier group 521B including group multiplier 524C, dedicated multiplier 524D, and accumulation adder 530. Multiplier groups 521A and 521B, group multipliers 524A and 524C, dedicated multipliers 524B and 524D, and accumulation adder 530 are substantially similar in structure and function to multiplier group 321, group multiplier 324B, dedicated multiplier 324A, and accumulation adder 330 of FIG. 3, respectively, except as otherwise indicated.

In integer mode, MAC unit 520 receives a plurality of integer values including activation 0 integer 544A, weight 0 integer 545A, activation 1 integer 544B, weight 1 integer 545B, activation 2 integer 544C, weight 2 integer 545C, activation 3 integer 544D, and weight 3 integer 545D. In integer mode, MAC unit 420 directs activation 0 integer 544A and weight 0 integer 545A to multiplier group 521A, directs activation 1 integer 544B and weight 1 integer 545B to dedicated multiplier 524B, directs activation 2 integer 544C and weight 2 integer 545C to multiplier group 521B, and directs activation 3 integer 544D and weight 3 integer 545D to dedicated multiplier 524D. In integer mode, multiplier group 521A and multiplier group 521B are dormant except for group multiplier 524A and group multiplier 524C, respectively. In integer mode, multiplier group 521A, dedicated multiplier 524B, multiplier group 521B, and dedicated multiplier 524D each transmit an integer product value to accumulation adder 530. In integer mode, accumulation adder adds the integer product values to produce intermediate integer value 556.

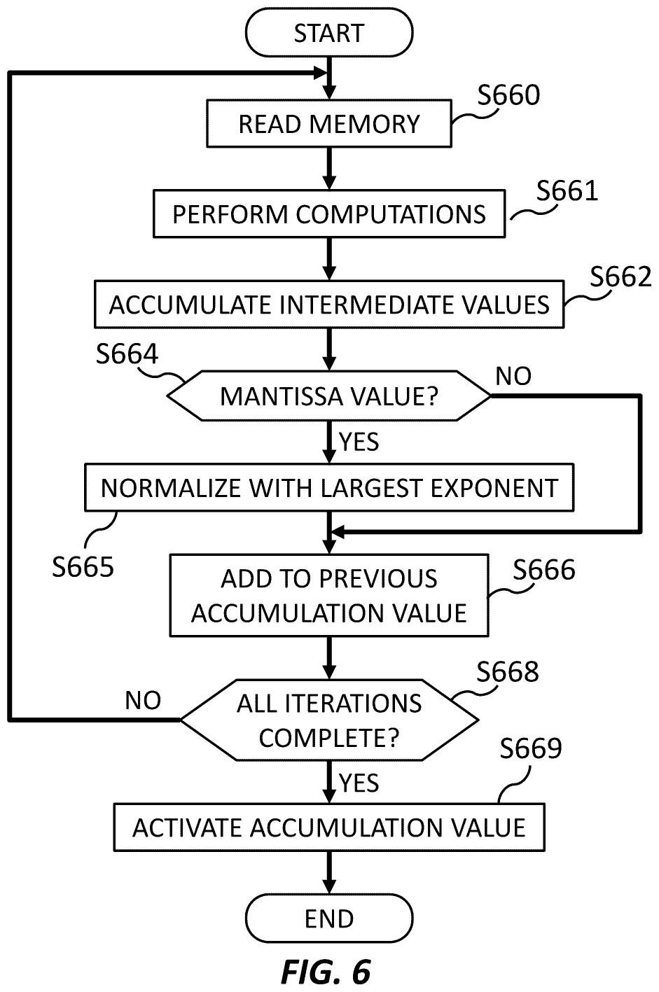

FIG. 6 is an operational flow for multiple-precision multiply-and-accumulate operation and activation, according to at least one embodiment of the present invention. The operational flow provides a method of multiple-precision multiply-and-accumulate operation and activation. In at least some embodiments, the method is performed by a controller of an integrated circuit, such as controller 118 of FIG. 1.

At S660, the controller reads a memory. In at least some embodiments, the controller reads the plurality of integer values from the memory in the integer mode. In at least some embodiments, the controller reads the plurality of floating point values from the memory in the floating point mode. In at least some embodiments, the controller causes a plurality of MAC units to collectively read the plurality of integer values from the memory in the integer mode and the plurality of floating point values in the floating point mode.

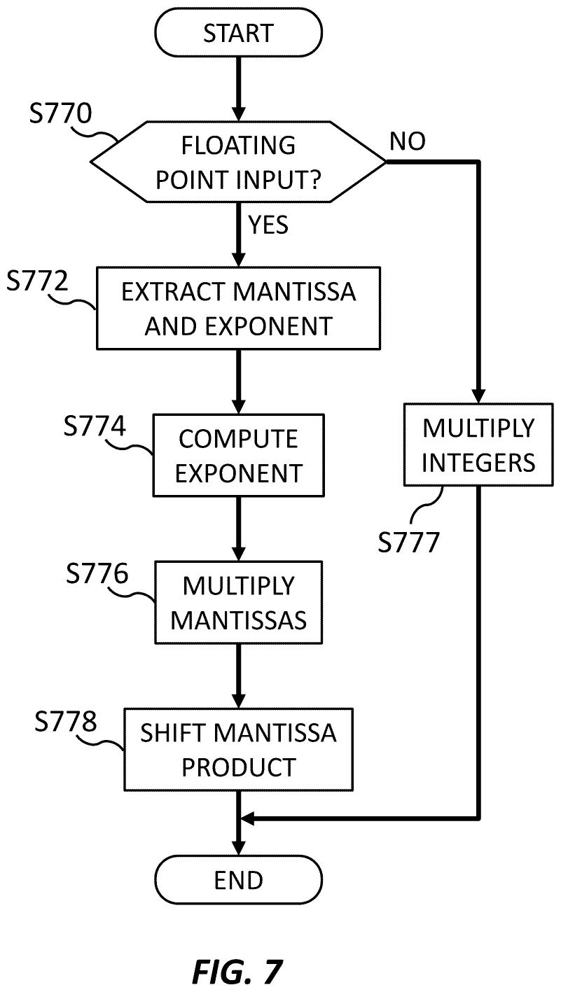

At S661, the controller performs computations. In at least some embodiments, the controller performs computations on the values read from the memory. In at least some embodiments, the controller causes the plurality of MAC units to compute intermediate values from the values read from the memory. In at least some embodiments, the controller causes each MAC unit to, in the integer mode, multiply two integer values among the plurality of integer values with the second multiplier to produce an intermediate integer value. In at least some embodiments, the controller performs the operations of FIG. 7, described hereinafter.

At S662, the controller accumulates intermediate values. In at least some embodiments, the controller accumulates intermediate values to produce an accumulation value. In at least some embodiments, the controller causes the plurality of accumulation adders to accumulate the intermediate mantissa values of the plurality of MAC units to produce an accumulation mantissa value in the floating point mode. In at least some embodiments, the controller causes the plurality of accumulation adders to accumulate the intermediate integer values of the plurality of MAC units to produce an accumulation integer value in the integer mode. In at least some embodiments in which each MAC unit includes an accumulation adder, each MAC unit is further configured to, in the integer mode, add the intermediate values produced from the group multiplier and the dedicated multiplier.

At S664, the controller determines whether the accumulation value is a mantissa value. In at least some embodiments, the floating point mode is indicated where the accumulation value is a mantissa value. In at least some embodiments, the integer mode is indicated where the accumulation value is an integer value. If the accumulation value is a mantissa value, then the operational flow proceeds to normalization at S665. If the accumulation value is not a mantissa value, then the operational flow proceeds to previous accumulation value addition at S666.

At S665, the controller normalizes the accumulation mantissa value with the largest exponent value. In at least some embodiments, the controller causes a normalizing accumulation adder to normalize the accumulation mantissa value with the largest exponent value. In at least some embodiments, the normalizing accumulation adder normalizes the accumulation mantissa value with the largest exponent value to produce a third data-width floating point value in the floating point mode. In at least some embodiments, the controller replaces the accumulation mantissa value with the twos complement where the accumulation mantissa value is negative. In at least some embodiments, the controller detects the leading one, and shifts the accumulation mantissa value left. In at least some embodiments, the controller computes the exponent value of the floating point value based on the largest exponent value, the number of MAC units in the plurality of MAC units, and the number of multipliers in each MAC unit. In at least some embodiments, the controller computes the exponent value according to E=E_{L}+log₂(M*S/2)+1−S_{L}, where E is the exponent of the floating point value, E_{L} is the largest exponent value, M is the number of MAC units in the plurality of MAC units, S is the number of multipliers in each MAC unit, and S_{L} is the shift left amount. In at least some embodiments, the controller concatenates a sign consistent with whether the accumulation value is positive or negative. In at least some embodiments, the controller causes the normalizing accumulation adder to produce a third data-width integer value without normalizing in the integer mode.

At S666, the controller adds the floating point value to a previously stored floating point value from a previous iteration. In at least some embodiments, the controller causes the normalizing accumulation adder to add the floating point value normalized at S665 of a previous iteration to the floating point value normalized at S665 of this iteration. In at least some embodiments, the controller causes the normalizing accumulation adder to add the accumulation integer value produced at S665 of a previous iteration to the accumulation integer value produced at S665 of this iteration. In at least some embodiments, if the computed exponent value is greater than 255 or less than zero, then the controller sets the accumulation mantissa value to zero, and clips the exponent value to 255 or zero. In at least some embodiments, the resulting value is stored in the memory.

At S668, the controller determines whether or not all iterations are complete. In at least some embodiments, controller is programmed to complete a predetermined number of iterations. If the controller determines that all iterations are not complete, then the operational flow returns to memory reading at S660. If the controller determines that all iterations are complete, then the operational flow proceeds to accumulation value activation at S669.

At S669, the controller activates the accumulation value. In at least some embodiments, the controller activates the resulting value stored in memory at S666. In at least some embodiments, the controller causes an integer activation pipeline to activate the third data-width integer value to produce an activated first data-width integer value. In at least some embodiments, the controller causes a floating poing activation pipeline to activate the third data-width floating point value to produce an activated second data-width floating point value. In at least some embodiments, activation functions include Sigmoid, GELU, SiLU, RELU, etc. In at least some embodiments, the controller performs the activation functions using an approximation function, which approximates the values based on the input. In at least some embodiments, the approximation function is a direct approximation, a linear approximation, or a polynomial approximation to the second or third degree. In at least some embodiments, the approximation function is a piece-wise linear approximation. In at least some embodiments, the piece-wise linear approximation of Y=MX+C is used, where M is the slope of the line, C is the offset, X is the input value, and Y is the activated value. In at least some embodiments, the approximation function is based on at least one look-up table (LUT), such as one LUT for slope and one LUT for offset. In at least some embodiments, once the slope and offset values are returned from the table, the slope is multiplied by the input value and added to the offset value.

FIG. 7 is an operational flow for performing a multiply-and-accumulate computation, according to at least one embodiment of the present invention. The operational flow provides a method of performing a multiply-and-accumulate computation, such as the computation performed at S661 of FIG. 6. In at least some embodiments, the method is performed by a MAC unit of a systolic array, such as MAC unit 320 of FIG. 3.

At S770, the MAC unit determines whether the input values are floating point values. In at least some embodiments, the MAC unit determines whether to apply a floating point mode or an integer mode. If the MAC unit determines that the input values are floating point values, then the operational flow proceeds to extraction at S772. If the MAC unit determines that the input values are not floating point values, then the operational flow proceeds to integer multiplication at S777.

At S772, the MAC unit extracts a mantissa and an exponent from each input floating point value. In at least some embodiments, the MAC unit causes an extractor to extract an exponent value and a mantissa value from each of a plurality of floating point values, each floating point value among the a plurality of floating point values having the second data width. In at least some embodiments, the MAC unit causes the extractor to split a mantissa and an exponent from among the concatenation of values that make up the second data-width floating point value. In at least some embodiments, the MAC unit causes the extractor to split bits 6 to 0, as the mantissa, from bits 14 to 8, as the exponent. In at least some embodiments, the MAC unit causes the extractor to replace bits 6 to 0 with the twos complement in the mantissa.

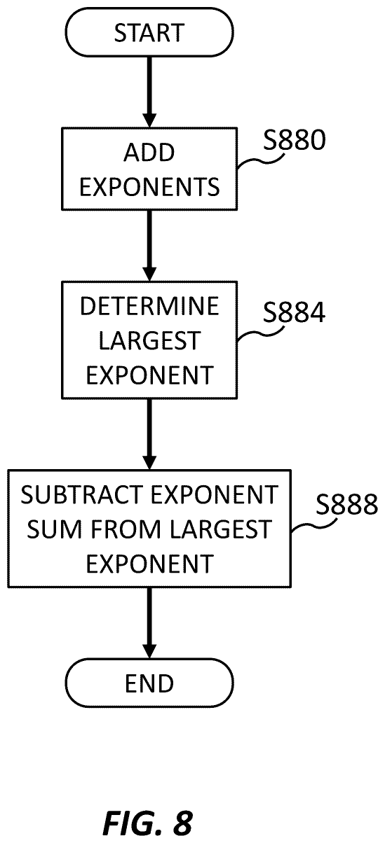

At S774, the MAC unit computes exponent values. In at least some embodiments, the MAC unit computes an exponent sum value, compares the exponent sum value with other exponent sum values, and determines a difference value from which to shift the mantissa product value. In at least some embodiments, the MAC unit performs the operational flow of FIG. 8, described hereinafter.

At S776, the MAC unit multiplies mantissa values. In at least some embodiments, the MAC unit causes a multiplier, such as a group multiplier, to multiply mantissa values extracted from each of two floating point values among the plurality of floating point values to produce a first mantissa product value. In at least some embodiments, the MAC unit causes a group multiplier of each multiplier group to multiply mantissa values to produce a mantissa product value.

At S777, the MAC unit multiplies integer values. In at least some embodiments, the MAC unit causes a multiplier, such as a group multiplier, a dedicated multiplier, or any combination thereof, to multiply two integer values among a plurality of integer values to produce an intermediate integer value, each integer value among the plurality of integer values having the first data width. In at least some embodiments, the MAC unit causes a group multiplier of each multiplier group and each dedicated multiplier to multiply integer values to produce an intermediate integer value.

At S778, the MAC unit shifts the mantissa product value. In at least some embodiments, the MAC unit causes a shifter to shift the first mantissa product value based on the difference value to produce an intermediate mantissa value. In at least some embodiments, the MAC unit causes a shifter of each multiplier group to shift mantissa product values to produce an intermediate mantissa value.

FIG. 8 is an operational flow for computing an exponent for a multiply-and-accumulate computation of a floating point value, according to at least one embodiment of the present invention. The operational flow provides a method of computing an exponent for a multiply-and-accumulate computation of a floating point value, such as the computation performed at S774 of FIG. 7. In at least some embodiments, the method is performed by a MAC unit of a systolic array, such as MAC unit 320 of FIG. 3.

At S880, the MAC unit adds exponent values. In at least some embodiments, the MAC unit causes an exponent adder to add exponent values extracted from each of two floating point values among a plurality of floating point values to produce an exponent sum value. In at least some embodiments, the MAC unit causes an exponent adder of each multiplier group to add exponent values to produce an exponent sum value.

At S884, the MAC unit determines a largest exponent value. In at least some embodiments, the MAC unit causes a comparator to determine a largest exponent value among a plurality of exponent sum values produced from the plurality of MAC units of the systolic array. In at least some embodiments, the MAC unit causes the comparator to determine a largest exponent value among a plurality of exponent values, including exponent values of third data-width floating point values resulting from previous iterations of computations.

At S888, the MAC unit subtracts the exponent sum value from the largest exponent value. In at least some embodiments, the MAC unit causes a subtractor to subtract the exponent sum value from the largest exponent value to produce a difference value. In at least some embodiments, the MAC unit causes a subtractor of each multiplier group to subtract an exponent value from the largest exponent value to produce a difference value.

At least some embodiments are described with reference to flowcharts and block diagrams whose blocks represent (1) steps of processes in which operations are performed or (2) sections of a controller responsible for performing operations. In at least some embodiments, certain steps and sections are implemented by dedicated circuitry, programmable circuitry supplied with computer-readable instructions stored on computer-readable media, and/or processors supplied with computer-readable instructions stored on computer-readable media. In at least some embodiments, dedicated circuitry includes digital and/or analog hardware circuits and include integrated circuits (IC) and/or discrete circuits. In at least some embodiments, programmable circuitry includes reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

In at least some embodiments, the computer readable storage medium includes a tangible device that is able to retain and store instructions for use by an instruction execution device. In some embodiments, the computer readable storage medium includes, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In at least some embodiments, computer readable program instructions described herein are downloadable to respective computing/processing devices from a computer readable storage medium or to an external computer or external storage device via a network, for example, the Internet, a local area network, a wide area network and/or a wireless network. In at least some embodiments, the network includes copper transmission cables, optical transmission fibers, wireless transmission, routers, firewalls, switches, gateway computers and/or edge servers. In at least some embodiments, a network adapter card or network interface in each computing/processing device receives computer readable program instructions from the network and forwards the computer readable program instructions for storage in a computer readable storage medium within the respective computing/processing device.

In at least some embodiments, computer readable program instructions for carrying out operations described above are assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In at least some embodiments, the computer readable program instructions are executed entirely on the user's computer, partly on the user's computer, as a stand-alone software package, partly on the user's computer and partly on a remote computer or entirely on the remote computer or server. In at least some embodiments, in the latter scenario, the remote computer is connected to the user's computer through any type of network, including a local area network (LAN) or a wide area network (WAN), or the connection is made to an external computer (for example, through the Internet using an Internet Service Provider). In at least some embodiments, electronic circuitry including, for example, programmable logic circuitry, field-programmable gate arrays (FPGA), or programmable logic arrays (PLA) execute the computer readable program instructions by utilizing state information of the computer readable program instructions to individualize the electronic circuitry, in order to perform aspects of the present invention.

While embodiments of the present invention have been described, the technical scope of any subject matter claimed is not limited to the above described embodiments. Persons skilled in the art would understand that various alterations and improvements to the above-described embodiments are possible. Persons skilled in the art would also understand from the scope of the claims that the embodiments added with such alterations or improvements are included in the technical scope of the invention.

The operations, procedures, steps, and stages of each process performed by an apparatus, system, program, and method shown in the claims, embodiments, or diagrams are able to be performed in any order as long as the order is not indicated by “prior to,” “before,” or the like and as long as the output from a previous process is not used in a later process. Even if the process flow is described using phrases such as “first” or “next” in the claims, embodiments, or diagrams, such a description does not necessarily mean that the processes must be performed in the described order.

In at least some embodiments, multiple-precision multiply-and-accumulate operation is performed by a multiply-and-accumulate (MAC) unit configured to operate in an integer mode to perform computations on first data-width integer values to produce third data-width integer values and configured to operate in a floating point mode to perform computations on second data-width floating point values to produce third data-width floating point values, wherein the second data width is twice the first data width and the third data width is larger than the second data width.

The foregoing outlines features of several embodiments so that those skilled in the art would better understand the aspects of the present disclosure. Those skilled in the art should appreciate that this disclosure is readily usable as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that various changes, substitutions, and alterations herein are possible without departing from the spirit and scope of the present disclosure.

What is claimed is:

1. An integrated circuit comprising:
a multiply-and-accumulate (MAC) unit configured to operate in an integer mode to perform computations on first data-width integer values to produce third data-width integer values and configured to operate in a floating point mode to perform computations on second data-width floating point values to produce third data-width floating point values, wherein the second data width is twice the first data width and the third data width is larger than the second data width, the MAC unit including a first multiplier, an exponent adder, a comparator, a subtractor, and a shifter,
wherein the MAC unit is configured to perform computations in the integer mode including multiplying two integer values among a plurality of integer values with the first multiplier to produce an intermediate integer value, each integer value among the plurality of integer values having the first data width, and
wherein the MAC unit is further configured to perform computations in the floating point mode including:
extracting an exponent value and a mantissa value from each of a plurality of floating point values, each floating point value among the a plurality of floating point values having the second data width,
multiplying, with the first multiplier, mantissa values extracted from each of two floating point values among the plurality of floating point values to produce a first mantissa product value,
adding, with the exponent adder, exponent values extracted from each of the two floating point values among the plurality of floating point values to produce an exponent sum value,
determining, with the comparator, a largest exponent value among a plurality of exponent sum values produced from the MAC unit,
subtracting, with the subtractor, the exponent sum value from the largest exponent value to produce a difference value, and
shifting, with the shifter, the first mantissa product value based on the difference value to produce an intermediate mantissa value;
an accumulation adder connected to two or more multipliers included in the MAC unit, the accumulation adder configured to
accumulate intermediate mantissa values of the MAC unit to produce an accumulation mantissa value in the floating point mode, and
accumulate intermediate integer values of the MAC unit to produce an accumulation integer value in the integer mode; and
a normalizing accumulation adder connected to the accumulation adder, the normalizing accumulation adder configured to
normalize the accumulation mantissa value with the largest exponent value to produce a third data-width floating point value in the floating point mode, and
produce a third data-width integer value without normalizing in the integer mode.

2. The integrated circuit of claim 1, further comprising:
a memory in communication with the MAC unit;
wherein the computations in the integer mode further include reading the plurality of integer values from the memory; and
wherein the computations in the floating point mode further include reading the plurality of floating point values from the memory.

3. The integrated circuit of claim 1, further comprising:
a controller in communication with the MAC unit, the controller configured to operate in the integer mode to perform neural network inference on first data-width integer values and configured to operate in the floating point mode to perform neural network inference on second data-width floating point values.

4. The integrated circuit of claim 1, further comprising:
an integer activation pipeline in communication with the memory, the integer activation pipeline configured to activate the third data-width integer value to produce an activated first data-width integer value.

5. The integrated circuit of claim 1, further comprising:
a floating point activation pipeline in communication with the memory, the floating point activation pipeline configured to activate the third data-width floating point value to produce an activated second data-width floating point value.

6. The integrated circuit of claim 1, wherein
the MAC unit further includes a second multiplier,
the MAC unit is further configured to, in the integer mode, multiply two integer values among the plurality of integer values with the second multiplier to produce an intermediate integer value, and
the MAC unit is further configured to refrain from using the second multiplier in the floating point mode.

7. The integrated circuit of claim 6, wherein
the MAC unit includes a plurality of instances of pairs of the first multiplier and the second multiplier, each first multiplier among the plurality of instances grouped with an instance of the exponent adder, an instance of the comparator, an instance of the subtractor, and an instance of the shifter, and
the MAC unit is further configured to perform the computations in the floating point mode for each first multiplier.

8. The integrated circuit of claim 1, further comprising:
a systolic array including
a plurality of instances of the MAC unit, wherein each instance of the MAC unit is further configured to perform, in the floating point mode, determining, with the comparator, the largest exponent value among the plurality of exponent sum values produced from the plurality of instances of the MAC unit of the systolic array, and
a plurality of accumulation adders, each accumulation adder connected to two or more of any combination of multipliers included in the plurality of instances of MAC units and preceding accumulation adders,
wherein the plurality of accumulation adders are collectively configured to
accumulate the intermediate mantissa values of the plurality of MAC units to produce the accumulation mantissa value in the floating point mode, and
accumulate the intermediate integer values of the plurality of MAC units to produce the accumulation integer value in the integer mode, and
wherein the plurality of accumulation adders includes the normalizing accumulation adder.

9. An integrated circuit comprising:
a multiply-and-accumulate (MAC) unit configured to operate in an integer mode to perform computations on first data-width integer values to produce third data-width integer values and configured to operate in a floating point mode to perform computations on second data-width floating point values to produce third data-width floating point values, wherein the second data width is twice the first data width and the third data width is larger than the second data width, the MAC unit including:
an extractor configured to extract an exponent value and a mantissa value from each of a plurality of second data-width floating point values, the extractor further configured to pass through at least two first data-width integer values among a plurality of first data-width integer values,
a first multiplier connected to the extractor, the first multiplier configured to multiply mantissa values extracted from each of two floating point values among the plurality of floating point values to produce a first mantissa product value, the first multiplier further configured to multiply two of the at least two first data-width integer values among the plurality of first data-width integer values to produce a first integer product value,
an exponent adder connected to the extractor, the exponent adder configured to add exponent values extracted from each of the two floating point values among the plurality of floating point values to produce an exponent sum value,
a comparator connected to the exponent adder, the comparator configured to determine a largest exponent value among a plurality of exponent sum values produced from the MAC unit,
a subtractor connected to the exponent adder and the comparator, the subtractor configured to subtract the exponent sum value from the largest exponent value to produce a difference value, and
a shifter connected to the subtractor and the first multiplier, the shifter configured to shift the first mantissa product value based on the difference value to produce an intermediate mantissa value, the shifter further configured to pass through the first integer product value as an intermediate integer value;
an accumulation adder configured to accumulate intermediate mantissa values of the MAC unit to produce an accumulation mantissa value, the accumulation adder further configured to accumulate intermediate integer values of the MAC unit to produce an accumulation integer value; and
a normalizing accumulation adder connected to the accumulation adder, the normalizing accumulation adder configured to normalize the accumulation mantissa value with the largest exponent value to produce a third data-width floating point value, the normalizing accumulation adder further configured to produce a third data-width integer value without normalizing.

10. The integrated circuit of claim 9, further comprising:
a memory in communication with the MAC unit;
wherein the MAC unit is configured to read the plurality of second data-width floating point values from the memory, the MAC unit further configured to read the plurality of first data-width integer values from the memory.

11. The integrated circuit of claim 9, further comprising:
a controller in communication with the MAC unit, the controller configured to operate in the integer mode to perform neural network inference on first data-width integer values and configured to operate in the floating point mode to perform neural network inference on second data-width floating point values.

12. The integrated circuit of claim 9, further comprising:
an integer activation pipeline in communication with the memory, the integer activation pipeline configured to perform activations on third data-width integer values to produce first data-width integer values.

13. The integrated circuit of claim 9, further comprising:
a floating point activation pipeline in communication with the memory, the floating point activation pipeline configured to perform activations on third data-width floating point values to produce second data-width floating point values.

14. The integrated circuit of claim 9, wherein
the MAC unit further includes a second multiplier, the second multiplier configured to multiply two first data-width integer values among the plurality of first data-width integer values to produce a second integer product value.

15. The integrated circuit of claim 9, further comprising:
a systolic array including
a plurality of instances of the MAC unit, wherein the comparator of each instance of the MAC unit is configured to determine the largest exponent value among the plurality of exponent sum values produced from the plurality of instances of the MAC unit of the systolic array, and
a plurality of accumulation adders, each accumulation adder connected to two or more of any combination of multipliers included in the plurality of instances of the MAC unit and preceding accumulation adders, the plurality of accumulation adders collectively configured to accumulate the intermediate mantissa values of the plurality of MAC units to produce the accumulation mantissa value, the plurality of accumulation adders collectively further configured to accumulate the intermediate integer values of the plurality of MAC units to produce the accumulation integer value,
wherein the plurality of accumulation adders includes the normalizing accumulation adder.

16. An integrated circuit comprising:
a plurality of multiplier groups configured to operate in an integer mode to perform computations on first data-width integer values to produce third data-width integer values and configured to operate in a floating point mode to perform computations on second data-width floating point values to produce third data-width floating point values, wherein the second data width is twice the first data width and the third data width is larger than the second data width, each multiplier group including:
an extractor configured to extract an exponent value and a mantissa value from each of a plurality of second data-width floating point values, the extractor further configured to pass through at least two first data-width integer values among a plurality of first data-width integer values,
a group multiplier connected to the extractor, the group multiplier configured to multiply mantissa values extracted from each of two floating point values among the plurality of floating point values to produce a first mantissa product value, the group multiplier further configured to multiply two of the at least two first data-width integer values among the plurality of first data-width integer values to produce a first integer product value,
an exponent adder connected to the extractor, the exponent adder configured to add exponent values extracted from each of the two floating point values among the plurality of floating point values to produce an exponent sum value,
a comparator connected to the exponent adder, the comparator configured to determine a largest exponent value among a plurality of exponent sum values produced from the plurality of multiplier groups,
a subtractor connected to the exponent adder and the comparator, the subtractor configured to subtract the exponent sum value from the largest exponent value to produce a difference value, and
a shifter connected to the subtractor and the group multiplier, the shifter configured to shift the first mantissa product value based on the difference value to produce an intermediate mantissa value, the shifter further configured to pass through the first integer product value as an intermediate integer value;
a plurality of dedicated multipliers, each dedicated multiplier configured to multiply two first data-width integer values among the plurality of first data-width integer values to produce a second integer product value;
an accumulation adder connected to shared multipliers among the plurality of multiplier groups and dedicated multipliers among the plurality of dedicated multipliers, the accumulation adder configured to accumulate the intermediate mantissa values of the plurality of multiplier groups to produce an accumulation mantissa value, the accumulation adder further configured to accumulate the intermediate integer values of the plurality of multiplier groups and the plurality of dedicated multipliers to produce an accumulation integer value; and
a normalizing accumulation adder configured to normalize the accumulation mantissa value with the largest exponent value to produce a third data-width floating point value, the normalizing accumulation adder further configured to produce a third data-width integer value without normalizing.

17. The integrated circuit of claim 16, further comprising:
a memory in communication with each multiplier group among the plurality of multiplier groups and each dedicated multiplier among the plurality of multipliers;
wherein each multiplier group is configured to read the plurality of second data-width floating point values from the memory, each multiplier group further configured to read the plurality of first data-width integer values from the memory.

18. The integrated circuit of claim 16, further comprising:
a controller in communication with the plurality of multiplier groups, the controller configured to operate in the integer mode to perform neural network inference on first data-width integer values and configured to operate in the floating point mode to perform neural network inference on second data-width floating point values.

19. The integrated circuit of claim 16, further comprising:
a floating point activation pipeline in communication with the memory, the floating point activation pipeline configured to perform activations on third data-width floating point values to produce second data-width floating point values.

20. The integrated circuit of claim 16, further comprising:
a systolic array including
the plurality of multiplier groups,
the plurality of dedicated multipliers, and
a plurality of accumulation adders, each accumulation adder connected to two or more of any combination of shared multipliers among the plurality of multiplier groups, dedicated multipliers among the plurality of dedicated multipliers, and preceding accumulation adders, the plurality of accumulation adders collectively configured to accumulate the intermediate mantissa values of the plurality of multiplier groups to produce the accumulation mantissa value, the plurality of accumulation adders collectively further configured to accumulate the intermediate integer values of the plurality of multiplier groups and the plurality of dedicated multipliers to produce the accumulation integer value,
wherein the plurality of accumulation adders includes the normalizing accumulation adder.
